(19) United States
(12) Patent Application Publication
(10) Pub. No.: US 2017/0088165 A1
(43) Pub. Date: Mar. 30, 2017

(54) DRIVER MONITORING

(71) Applicant: GM GLOBAL TECHNOLOGY OPERATIONS LLC, Detroit, MI (US)

(72) Inventors: ERIC L. RAPHAEL, BIRMINGHAM, MI (US); BAKHTIAR B. LITKOUHI, WASHINGTON, MI (US); JEREMY A. SALINGER, SOUTHFIELD, MI (US)

(21) Appl. No.: 14/868,555

(22) Filed: Sep. 29, 2015

(51) Int. Cl. B62D 6/00; B60Q 9/00; G06K 9/00; B62D 15/02

(52) U.S. Cl. CPC B62D 6/002; B62D 6/001; B62D 15/029; B62D 15/0265; B60Q 9/00; G06K 9/00845

(57) ABSTRACT

Methods and systems for monitoring a driver of a vehicle are provided. In accordance with one embodiment, a system includes a sensing unit and a processor. The sensing unit is configured to at least facilitate detecting whether a driver of a vehicle is looking or has recently looked in a direction with respect to the vehicle. The processor is coupled to the sensing unit, and is configured to at least facilitate providing an action based at least in part on whether the driver is looking or has recently looked in the direction.

### TECHNICAL FIELD

The present disclosure generally relates to vehicles, and more particularly relates to methods and systems for monitoring drivers of vehicles.

### BACKGROUND

Many vehicles today include various systems that can improve driving experience and/or safety. Such systems may include, among others, active safety systems, avoidance systems, steering assist systems, automatic steering systems, and semi-automatic steering systems. It may be desired to further customize such systems based on the driver of the vehicle.

Accordingly, it is desirable to provide techniques for monitoring a driver of a vehicle, and for taking actions based on the monitoring of the driver. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method comprises detecting whether a driver of a vehicle is looking in a direction with respect to the vehicle, and providing an action based at least in part on whether the driver is looking in the direction.

In accordance with another exemplary embodiment, a system is provided. The system comprises a sensing unit and a processor. The sensing unit is configured to at least facilitate detecting whether a driver of a vehicle is looking in a direction with respect to the vehicle. The processor is coupled to the sensing unit, and is configured to at least facilitate providing an action based at least in part on whether the driver is looking or has recently looked in the direction.

In accordance with a further exemplary embodiment, a vehicle is provided. The vehicle comprises a body, a steering system, a sensing unit, and a processor. The steering system is formed with the body. The sensing unit is configured to at least facilitate detecting whether a driver of the vehicle is looking in a direction with respect to the vehicle. The processor is coupled to the sensing unit and the steering system, and is configured to at least facilitate providing a steering action based at least in part on whether the driver is looking or has recently looked in the direction

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for monitoring a driver of the vehicle and for taking appropriate actions based at least in part on the monitoring of the driver, in accordance with an exemplary embodiment;

FIG. 2 is a schematic drawing of a portion of a steering system of the vehicle of FIG. 1, in accordance with an exemplary embodiment.

FIG. 3 is a flowchart of a process for monitoring a driver of the vehicle, and that can be used in connection with the vehicle of FIG. 1, in accordance with an exemplary embodiment;

FIG. 4 is a more detailed flowchart of one embodiment of the process of FIG. 3, and that can be used in connection with the vehicle of FIG. 1, in accordance with an exemplary embodiment; and

FIG. 5 is a representation of an implementation of the process of FIG. 4 using the vehicle of FIG. 1 on a roadway, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

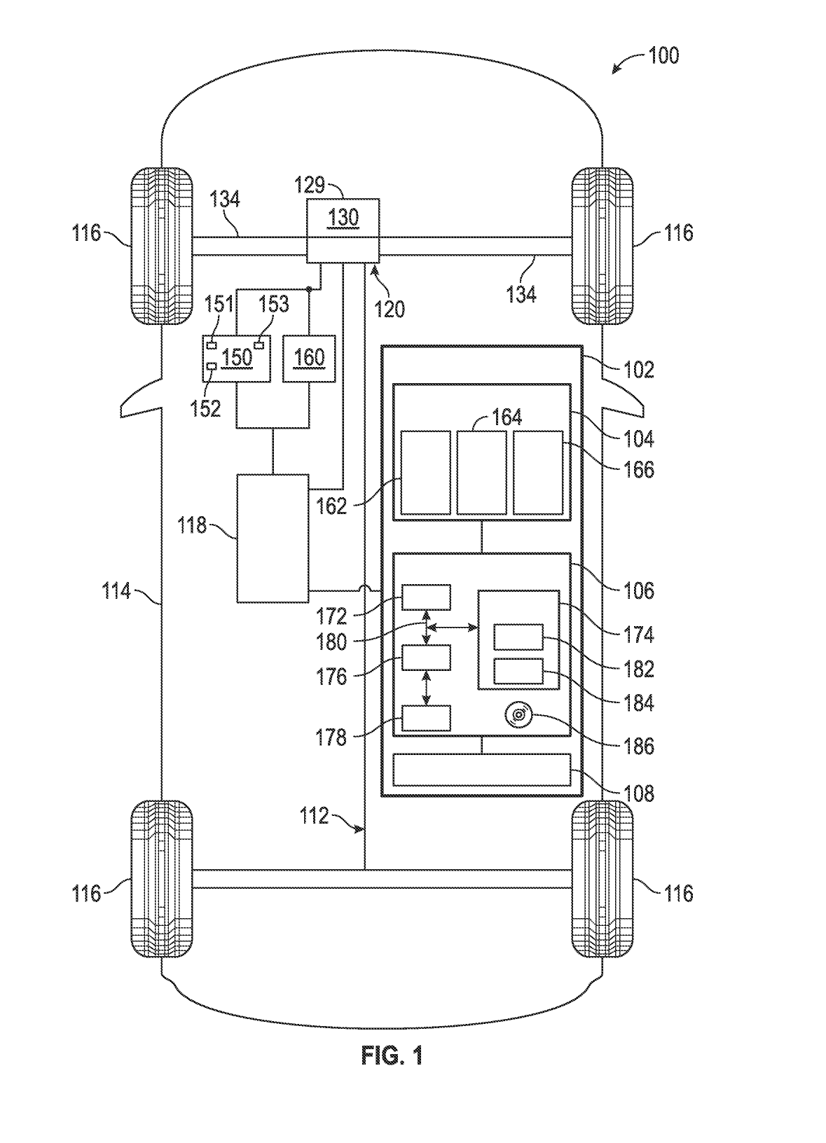

FIG. 1 illustrates a vehicle 100, or automobile, according to an exemplary embodiment. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD).

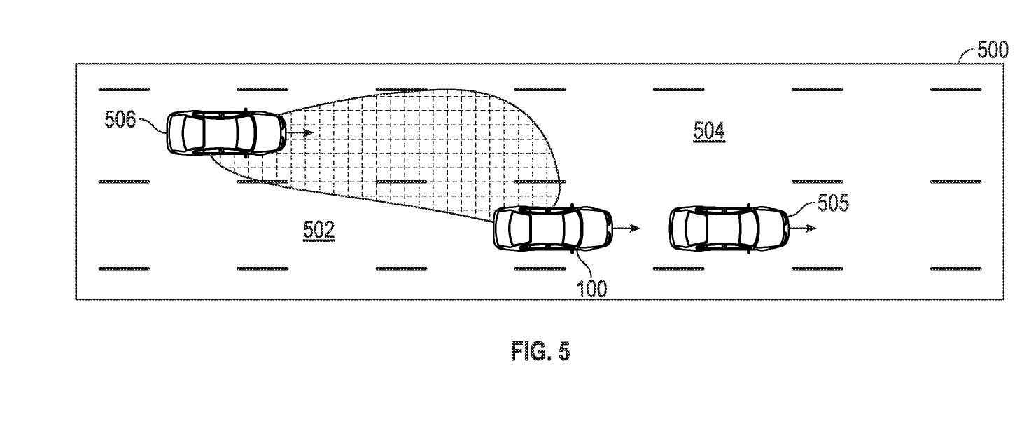

As described in greater detail further below, the vehicle 100 includes a control system 102 for monitoring a driver of the vehicle 100, and for taking appropriate actions based on the monitoring. As discussed further below, the control system 102 includes a sensor array 104, a controller 106, and a notification unit 108. In various embodiments, the controller 106 controls the performance of one or more actions for the vehicle 100 based at least in part on the monitoring of the driver of the vehicle 100, in accordance with the steps set forth further below in connection with the processes 300, 400 of FIGS. 3-5.

As depicted in FIG. 1, the vehicle 100 includes, in addition to the above-referenced control system 102, a chassis 112, a body 114, four wheels 116, an electronic control system 118, a steering system 150, and a braking system 160. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114. In various embodiments the vehicle 100 may differ from that depicted in FIG. 1. For example, in certain embodiments the number of wheels 116 may vary. By way of additional example, in various embodiments the vehicle 100 may not have a steering system, and for example may be steered by differential braking, among various other possible differences.

In the exemplary embodiment illustrated in FIG. 1, the vehicle 100 includes an actuator assembly 120. The actuator assembly 120 includes at least one propulsion system 129 mounted on the chassis 112 that drives the wheels 116. In the depicted embodiment, the actuator assembly 120 includes an engine 130. In one embodiment, the engine 130 comprises a combustion engine. In other embodiments, the actuator assembly 120 may include one or more other types of engines and/or motors, such as an electric motor/generator, instead of or in addition to the combustion engine. In certain embodiments, the electronic control system 118 comprises an engine control system that controls the engine 130 and/or one or more other systems of the vehicle 100.

Still referring to FIG. 1, the engine 130 is coupled to at least some of the wheels 116 through one or more drive shafts 134. In some embodiments, the engine 130 is mechanically coupled to the transmission. In other embodiments, the engine 130 may instead be coupled to a generator used to power an electric motor that is mechanically coupled to the transmission. In certain other embodiments (e.g. electrical vehicles), an engine and/or transmission may not be necessary.

The steering system 150 is mounted on the chassis 112, and controls steering of the wheels 116. In the depicted embodiment, the steering system 150 includes a steering wheel 151, a steering column 152, and a turn signal 153. In various embodiments, the steering wheel 151 and turn signal 153 receive inputs from a driver of the vehicle 100 when a turn is desired. The steering column 152 results in desired steering angles for the wheels 116 via the drive shafts 134 based on the inputs from the driver. In certain embodiments, an autonomous vehicle may utilize steering commands that are generated by a computer, with no involvement from the driver.

The braking system 160 is mounted on the chassis 112, and provides braking for the vehicle 100. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle, as well as various other inputs for various vehicle devices and/or systems, such as one or more vehicle radios, other entertainment systems, environmental control systems, lighting units, navigation systems, and the like (also not depicted). Similar to the discussion above regarding possible variations for the vehicle 100, in certain embodiments steering, braking, and/or acceleration can be commanded by a computer instead of by a driver.

The control system 102 is mounted on the chassis 112. As discussed above, the control system 102 controls an adaptive cruise control feature of the vehicle 100. In one embodiment, the control system 102 provides monitoring of the driver of the vehicle 100, and provides actions (such as executing a turn into a desired lane, providing steering assist, providing a notification, and/or one or more other vehicle actions) based at least in part on the monitoring of the driver. In certain embodiments, the control system 102 may comprise, may be part of, and/or may be coupled to the electronic control system 118, the steering system 150, one or more active safety systems, and/or more other systems of the vehicle 100.

As noted above and depicted in FIG. 1, in one embodiment the control system 102 comprises a sensor array 104, a controller 106, and a notification unit 108. The sensor array 104 includes various sensors (also referred to herein as sensor units and/or detection units) that are used for monitoring the vehicle 100, the driver of the vehicle 100, and/or one or more conditions proximate the vehicle 100. In the depicted embodiment, the sensor array 104 includes a driver input detection unit 162, a driver detection unit 164, and a road detection unit 166.

The driver input detection unit 162 detects one or more inputs provided by the driver of the vehicle 100. In certain embodiments, the driver input detection unit 162 comprises one or more sensors configured to detect when a driver has engaged the steering wheel 151 and/or the turn signal 153 of the vehicle 100. Also in certain embodiments, the driver input detection unit 162 further comprises sensors configured to detect when the driver has initiated a starting of an ignition of the vehicle 100 (e.g. by turning a key of the ignition, pressing a start button, and/or engaging a keyfob).

The driver detection unit 164 monitors a driver of the vehicle 100. In one embodiment, the driver detection unit 164 comprises one or more sensors configured to monitor a position and/or movement of a head of the driver. In another embodiment, the driver detection unit 164 comprises one or more sensors configured to monitor a position and/or movement of eyes of the driver. In yet another embodiment, the driver detection unit 164 comprises one or more sensors configured to monitor a position and/or movement of both the head and eyes of the driver.

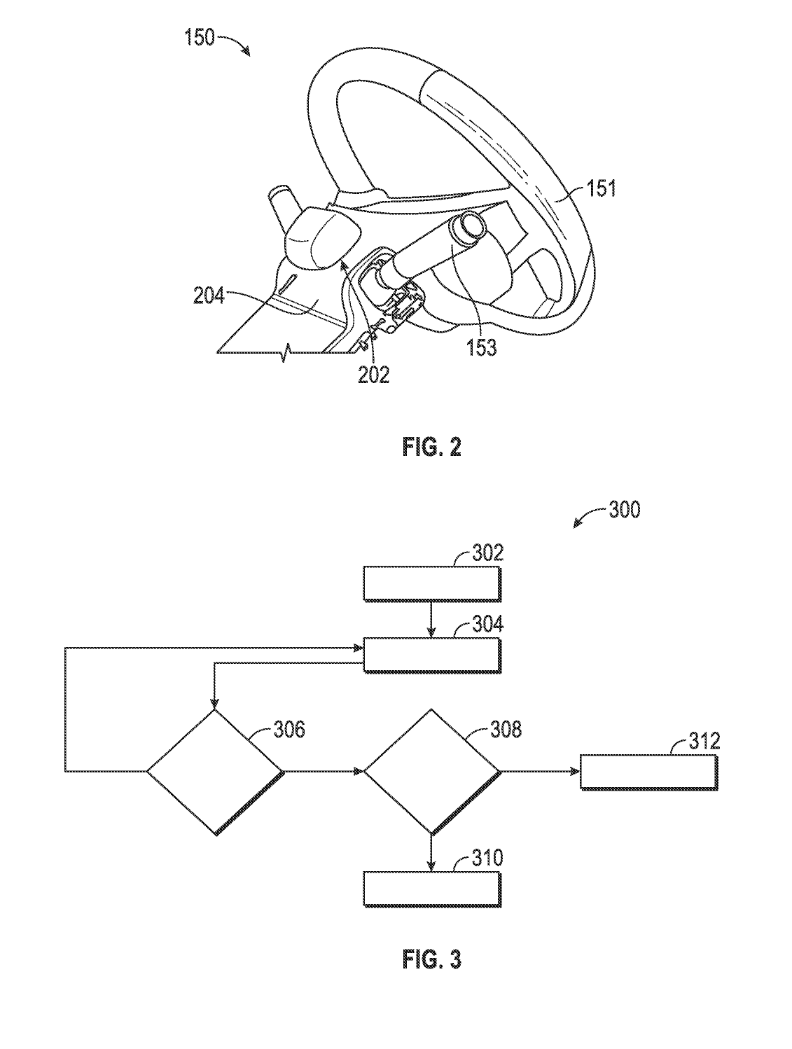

With reference to FIG. 2, in one embodiment one or more sensors 202 of the driver detection unit 164 are installed on a housing 204 of the steering system 150 of FIG. 1, for example proximate the steering wheel 151 as depicted in FIG. 2. In various embodiments, sensors of the driver detection unit 164 may also be installed on one or more other locations of the vehicle 100, for example on an A-pillar of the vehicle, on a rear view mirror assembly, and/or on one or more other locations of the vehicle 100. In addition, in certain embodiments, the sensors 202 may include one or more cameras and/or one or processors. For example, in certain embodiments, such a processor may run a program that evaluates the images produced by the camera(s) to determine the direction and movement of the eyes and/or head of the driver. The direction and movement may be utilized, for example, for ascertaining whether the driver is looking in a particular direction for a minimum amount of time to satisfy the criteria for looking in the required direction.

With reference again to FIG. 1, the road detection unit 166 monitors objects proximate the vehicle 100. In certain embodiments, the road detection unit 166 monitors other vehicles and other objects proximate a path on which the vehicle 100 is travelling (e.g. including a lane in which the vehicle 100 is travelling along with adjacent lanes of a roadway or other path). In various embodiments, the road detection unit 166 includes one or more sensors, including, without limitation, one or more cameras, radar, sonar, lidar, and/or other types of sensors. Also in various embodiments, such sensors may be mounted at various locations along the body 114 of the vehicle 100.

In various embodiments, the sensor array 104 provides the detected information to the controller for processing. Also in various embodiments, the controller 106 performs these and other functions in accordance with the steps of the processes 300, 400 described further below in connection with FIGS. 3-5.

The controller 106 is coupled to the sensor array 104 and to the notification unit 108. The controller 106 utilizes the various measurements and information from the sensor array 104, and controls one or more actions (e.g. steering and/or warnings) based at least in part on a monitoring of the driver of the vehicle 100. In various embodiments, the controller 106, along with the sensor array 104 and the notification unit 108, provide these and other functions in accordance with the steps discussed further below in connection with the schematic drawings of the vehicle 100 in FIG. 1 and the flowcharts and schematic drawings pertaining to the processes 300 and 400 in FIGS. 3-5, discussed further below.

As depicted in FIG. 1, the controller 106 comprises a computer system. In certain embodiments, the controller 106 may also include one or more of the sensors of the sensor array 104, one or more other devices and/or systems, and/or components thereof In addition, it will be appreciated that the controller 106 may otherwise differ from the embodiment depicted in FIG. 1. For example, the controller 106 may be coupled to or may otherwise utilize one or more remote computer systems and/or other control systems, such as the electronic control system 118 and/or the steering system 150 of FIG. 1, and/or one or more other systems of the vehicle 100.

In the depicted embodiment, the computer system of the controller 106 includes a processor 172, a memory 174, an interface 176, a storage device 178, and a bus 180. The processor 172 performs the computation and control functions of the controller 106, and may comprise any type of processor or multiple processors, single integrated circuits such as a microprocessor, or any suitable number of integrated circuit devices and/or circuit boards working in cooperation to accomplish the functions of a processing unit. During operation, the processor 172 executes one or more programs 182 contained within the memory 174 and, as such, controls the general operation of the controller 106 and the computer system of the controller 106, generally in executing the processes described herein, such as the processes 300, 400 described further below in connection with FIGS. 3-5.

The memory 174 can be any type of suitable memory. For example, the memory 174 may include various types of dynamic random access memory (DRAM) such as SDRAM, the various types of static RAM (SRAM), and the various types of non-volatile memory (PROM, EPROM, and flash). In certain examples, the memory 174 is located on and/or co-located on the same computer chip as the processor 172. In the depicted embodiment, the memory 174 stores the above-referenced program 182 along with one or more stored values 184.

The bus 180 serves to transmit programs, data, status and other information or signals between the various components of the computer system of the controller 106. The interface 176 allows communication to the computer system of the controller 106, for example from a system driver and/or another computer system, and can be implemented using any suitable method and apparatus. In one embodiment, the interface 176 obtains the various data from the sensors of the sensor array 104. The interface 176 can include one or more network interfaces to communicate with other systems or components. The interface 176 may also include one or more network interfaces to communicate with technicians, and/or one or more storage interfaces to connect to storage apparatuses, such as the storage device 178.

The storage device 178 can be any suitable type of storage apparatus, including direct access storage devices such as hard disk drives, flash systems, floppy disk drives and optical disk drives. In one exemplary embodiment, the storage device 178 comprises a program product from which memory 174 can receive a program 182 that executes one or more embodiments of one or more processes of the present disclosure, such as the steps of the processes 300, 400 (and any sub-processes thereof) described further below in connection with FIGS. 3-5. In another exemplary embodiment, the program product may be directly stored in and/or otherwise accessed by the memory 174 and/or a disk (e.g., disk 186), such as that referenced below.

The bus 180 can be any suitable physical or logical means of connecting computer systems and components. This includes, but is not limited to, direct hard-wired connections, fiber optics, infrared and wireless bus technologies. During operation, the program 182 is stored in the memory 174 and executed by the processor 172.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 172) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 106 may also otherwise differ from the embodiment depicted in FIG. 1, for example in that the computer system of the controller 106 may be coupled to or may otherwise utilize one or more remote computer systems and/or other control systems.

The notification unit 108 is coupled to the controller 106, and provides notifications for the driver of the vehicle 100. In certain embodiments, the notification unit 108 provides audio, visual, haptic, and/or other notifications to the driver based on instructions provided from the controller 106 (e.g. from the processor 172 thereof), for example when an object in proximity to the vehicle 100 may be a threat to the vehicle 100 and/or when a desired turn may not presently be executed (e.g. if the driver is not looking in the direction of the intended turn). Also in various embodiments, the notification unit 108 performs these and other functions in accordance with the steps of the processes 300, 400 described further below in connection with FIGS. 3-5.

While the components of the control system 102 (including the sensor array 104, the controller 106, and the notification unit 108) are depicted as being part of the same system, it will be appreciated that in certain embodiments these features may comprise two or more systems. In addition, in various embodiments the control system 102 may comprise all or part of, and/or may be coupled to, various other vehicle devices and systems, such as, among others, the actuator assembly 120, the electronic control system 118, the steering system 150, and/or one or more other systems of the vehicle 100.

FIG. 3 is a flowchart of a process 300 for monitoring a driver of a vehicle 100, in accordance with an exemplary embodiment. The process 300 can be implemented in connection with the vehicle 100 of FIG. 1, in accordance with an exemplary embodiment.

As depicted in FIG. 3, the process 300 is initiated at step 302. For example, in various embodiments, the process 300 may be initiated when the vehicle 100 starts in a driving mode, for example at the beginning of a current vehicle drive or ignition cycle, as detected by the driver input detection unit 162 of FIG. 1. In one embodiment, the process 300 is initiated when a driver has engaged an ignition of the vehicle 100 (e.g. by turning a key of the ignition, pressing a start button, and/or engaging a keyfob). In one embodiment, the process 300 continues throughout the ignition cycle or vehicle drive.

Monitoring is performed for the driver (step 304). In various embodiments, a driver is monitored to ascertain whether the driver is looking in a particular direction. In one embodiment, the monitoring includes detection and monitoring of the position and movement of the driver's eyes. In another embodiment, the monitoring includes detection and monitoring of the position and movement of the driver's head. In yet other embodiments, the monitoring includes detection and monitoring of the position and movement of both the driver's eyes and head. In addition, in various embodiments, the monitoring includes detecting whether the driver is looking in the direction of a particular object, threat, and/or lane proximate the vehicle. Also in one embodiment, the monitoring of step 304 is performed via measurements and/or detection provided by one or more sensors of the driver detection unit 164 of FIG. 1. In one embodiment, the monitoring is performed at least in part by the processor 172 of FIG. 1 based on such inputs provided by the driver detection unit 164.

A determination is made as to whether an event condition is satisfied (step 306). In one embodiment, this determination is made by the processor 172 of FIG. 1 based on information provided by the sensor array 104 of FIG. 1. In one embodiment, the action comprises a warning, and the event condition is deemed to be satisfied if a threat is present near the vehicle 100 that may justify a warning (e.g. if another vehicle and/or another object (hereafter collectively referred to as an “object”) poses a threat to the vehicle 100 (for example if the object is approaching the vehicle 100, has a distance to the vehicle 100 that is less than a predetermined distance threshold, and/or has an estimated time to collision with the vehicle 100 that is less than a predetermined time threshold) as determined using data from the road detection unit 166 of FIG. 1. In another embodiment, the action comprises a steering assist feature, and the event condition is deemed to be satisfied if a threat is present (e.g. from a nearby object, similar to the discussion above) that may require additional steering torque for avoidance (above what the driver is believed to provide) as determined using data from the road detection unit 166 of FIG. 1. In another embodiment, the action comprises a turn into an adjacent lane, and the event condition is deemed to be satisfied when the driver has indicated a desire to make a turn (e.g. by engaging the steering wheel 151 and/or the turn signal 153 of FIG. 1, and/or the driver's engagement of turn button and/or other turn indicator, use of a hand signal or voice command to indicate a turn, and so on) as determined using data from the driver detection unit 164 of FIG. 1, and the lane in which the turn is desired is clear of obstacles (such that a safe turn can be made into the lane) as determined using data from the road detection unit 166 of FIG. 1.

If it is determined that the event condition is not satisfied, then the process returns to step 304, as the driver continues to be monitored in a new iteration. Once a determination is made in an iteration of step 306, then the proceeds to step 308, described directly below.

During step 308, a determination is made as to whether a driver condition is satisfied. In one embodiment, this determination is made by the processor 172 of FIG. 1 based on information provided by the driver detection unit 164 of FIG. 1. In one embodiment, the driver condition is satisfied if the driver is deemed to be looking in the direction of the event of step 306 (e.g., if the driver is looking in the direction of the threat and/or object in examples in which a threat or object is at issue, and/or is looking in the direction of the desired turn when a desired turn is at issue) or if the driver has recently looked in the direction of the desired turn (e.g. within a few seconds, or within a shorter time interval, which may vary in different embodiments). Also in one embodiment, this determination is based on the monitoring of the head and/or eyes of the driver by the driver detection unit 164.

Different actions (or lack of action) are provided based on whether the driver condition of step 308 is satisfied. Specifically, as depicted in one embodiment, a first action is provided in step 310 if the driver condition is satisfied, and a second is provided in step 312 if the driver condition is not satisfied. Also in various embodiments, the actions are implemented at least in part based on instructions provided by the processor 172 of FIG. 1.

In one example in which the event condition is satisfied when a threat is present near the vehicle 100 that may justify a warning, the warning is not provided (or may be delayed) in step 310 if the driver is already looking in the direction of the threat, but the warning is provided in step 312 if the driver is not looking in the direction of the threat. In another example in which the event condition is satisfied when a threat may warrant use of a steering assist feature, the steering assist (e.g. added steering torque) is provided in step 310 if the driver is looking in an appropriate direction (in one example this may be the direction of the threat, and in another example this may be the intended steering direction), and the steering assist is not provided in step 312 if the driver is not looking in the appropriate direction. In another example in which the event condition is satisfied when the driver has indicated a desire to make a turn (e.g. by engaging the steering wheel 151 and/or the turn signal 153 of FIG. 1, and/or the driver's engagement of turn button and/or other turn indicator, use of a hand signal or voice command to indicate a turn, and so on), the turn (e.g. an automatic turn and/or a turn assist via additional torque) is provided in step 310 if the driver is looking in the direction of the intended turn, and the turn is not provided (and, for example, a notification to this effect may also be provided) in step 312 if the driver is not looking in the direction of the intended turn. Similar to the discussion above, in certain embodiments the driver may be deemed to be looking in the particular direction of interest, for the decision making purposes of the process, if the driver has recently looked in the direction of interest (e.g. within a few seconds, or within a shorter time interval, which may vary in different embodiments) In addition, in certain embodiments, if the driver is looking in the direction of a threat, then the timing of an alert or steering assist may be altered, for example by waiting for the alert or steering assist until the threat reaches a relatively more significant level (e.g. until the threat is closer to the vehicle, in one embodiment).

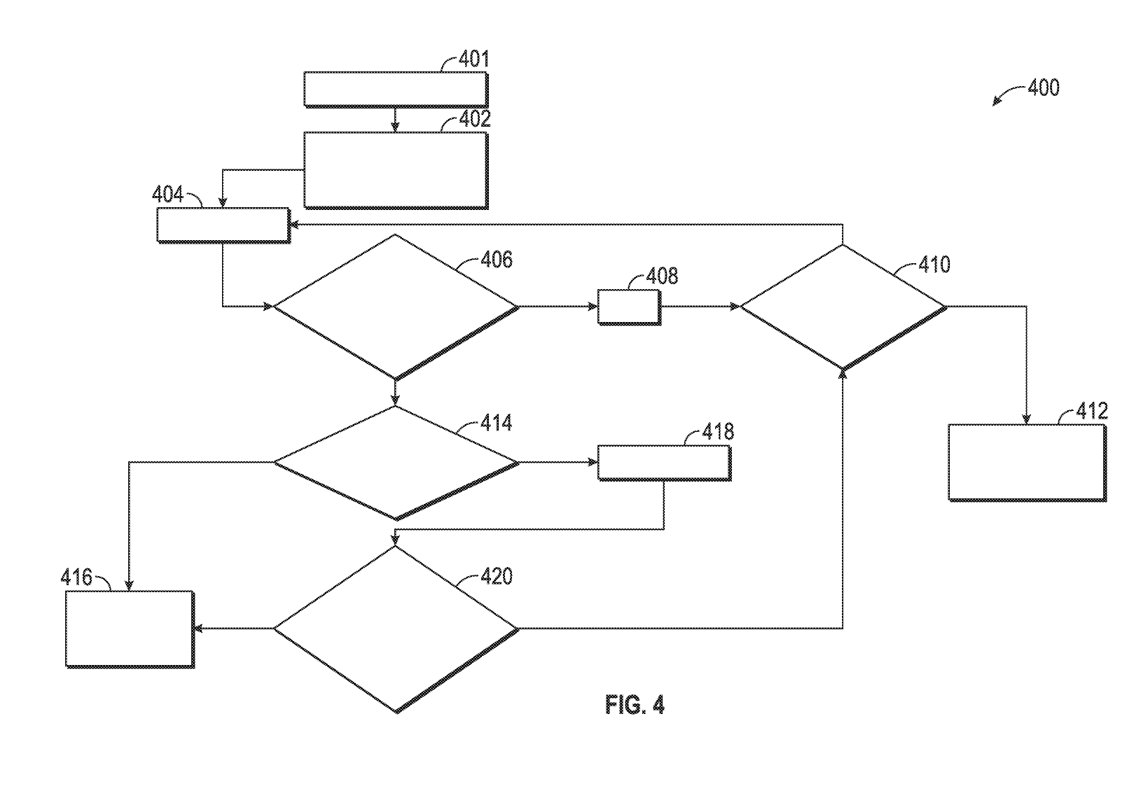

FIG. 4 is a more detailed flowchart of one embodiment of the process 300 of FIG. 3, referred to as process 400 with reference to FIG. 4, in accordance with an exemplary embodiment. The process 400 can be used in connection with the vehicle 100 of FIG. 1, in accordance with an exemplary embodiment.

FIG. 4 is a more detailed flowchart of one embodiment of the process 300 of FIG. 3, referred to as process 400 with reference to FIG. 4, in accordance with an exemplary embodiment. The process 400 can be used in connection with the vehicle 100 of FIG. 1, in accordance with an exemplary embodiment.

As depicted in FIG. 4, the process 400 is initiated at step 401. For example, in various embodiments, the process 400 may be initiated when the vehicle 100 starts in a driving mode, for example at the beginning of a current vehicle drive or ignition cycle, as detected by the driver input detection unit 162 of FIG. 1. In one embodiment, the process 300 is initiated when a driver has engaged an ignition of the vehicle 100 (e.g. by turning a key of the ignition, pressing a start button, and/or engaging a keyfob). In one embodiment, the process 400 continues throughout the ignition cycle or vehicle drive. Also in one embodiment, step 401 of FIG. 4 corresponds to step 302 of FIG. 3.

A determination is made that the driver has requested a lane change for the vehicle (step 402). In one embodiment, this determination is made by the processor 172 of FIG. 1 when the driver has engaged the turn signal 153 of FIG. 1 in a manner requesting that a turn be made. In another embodiment, this determination is made by the processor 172 of FIG. 1 when the driver has engaged the steering wheel 151 of FIG. 1 in a manner requesting that a turn be made. In yet other embodiments, this determination may be made when the driver has taken one or more other actions to indicate a desire to make a turn, for example by the driver's engagement of turn button and/or other turn indicator, use of a hand signal or voice command to indicate a turn, and so on).

A path or road on which the vehicle is travelling is monitored (step 404). In one embodiment, the road on which the vehicle is travelling (including the vehicle's lane and any adjacent lanes, and any lanes that may affect the turn into the desired lane) is monitored using the data from the road detection unit 166 of FIG. 1. Also in one embodiment, the road is monitored in this manner for any objects (also referred to herein as obstacles) that may be travelling within, toward, and/or otherwise impacting the ability of the vehicle 100 to turn safely into the desired lane. In one embodiment, the road monitoring of step 404 is performed continuously, once the initiation of step 401 is made.

A determination is made as to whether there is a sufficient level of confidence that it would be unsafe for the vehicle to turn into the desired lane (step 406). In one embodiment, this determination is made by the processor 172 of FIG. 1 using the data from the monitoring of step 404 by the road detection unit 166 of FIG. 1, for example based on whether any objects are presently within or headed toward the desired lane proximate the vehicle. In one embodiment, a sufficient level of confidence may comprise that two or more sensors observing the area of interest agree that there is an obstacle in the area of concern. In another embodiment, a sufficient level of confidence may comprise a signal from the area of concern that is strong and persists for some period of time (e.g. a few seconds or a shorter interval, which may vary in different embodiments).

If it is determined in step 406 that there is a sufficient level of confidence that it would be unsafe to change lanes, then the vehicle waits a short time, without changing lanes (step 408) before evaluating the situation again. In one embodiment, the vehicle waits for a fraction of a second (e.g. half of a second in one example, although this may vary in other embodiments). In one embodiment, this is performed for the vehicle 100 via instructions provided by the processor 172 to the steering system 150 of FIG. 1. In addition, the process proceeds to step 410, described directly below.

During step 410, a determination is made as to whether a maximum amount of wait time to make the turn has been reached (step 410). In one embodiment, this determination is made by the processor 172 of FIG. 1. Also in one embodiment, the maximum amount of time comprises a predetermined amount of time (e.g. stored as one of the stored values 184 in the memory 174 of FIG. 1) during which further road monitoring and road check could occur in steps 404 and 406. In one embodiment, the maximum wait time is equal to approximately fifteen seconds (15 sec). However, this may vary in other embodiments.

If it is determined in step 410 that the maximum wait time has been reached, then the lane change is not executed (step 412). Specifically, in one embodiment, during step 412 a lane change on demand function is exited, and no lane change is executed unless and until a subsequent request is received in a future iteration of step 402. In addition, in one embodiment, a notification is provided to the driver. In one such embodiment, an audio and/or visual notification is provided by the notification unit 108 of FIG. 1, based on instructions provided by the processor 172 of FIG. 1, notifying the driver that the requested turn cannot be executed at the present time. In one embodiment, the process then terminates until a subsequent turn request is made in step 402 (in some embodiments, the road monitoring of step 404 and/or the driver monitoring of step 418, discussed below, is still performed in the interim).

Conversely, if it is determined in step 410 that the maximum wait time has not been reached, then the process returns to step 404 in a new iteration. The process then continues with further monitoring of the road in step 404 and a subsequent determination in step 406 with the new, updated road monitoring data.

With reference back to step 406, if it is determined in step 406 that there is not a sufficient level of confidence that it would be unsafe for the vehicle to turn into the desired lane, then a separate determination is made as to whether there is a sufficient level of confidence that it would be safe for the vehicle to turn into the desired lane (step 414). In one embodiment, this determination is made by the processor 172 of FIG. 1 using the data from the monitoring of step 404 by the road detection unit 166 of FIG. 1, for example based on whether the intended turn path for the vehicle 100 is clear of objects. In one embodiment, a sufficient level of confidence would be deemed to exist for it being safe for the vehicle to turn if there is more than one sensor that can observe the area of concern and all such sensors indicate that there are no obstacles in that area.

If it is determined in step 414 that there is a sufficient level of confidence that it would be safe to change lanes, then the requested turn is executed (step 416). In one embodiment, in step 416 the vehicle 100 is turned into the desired lane (per the request in step 402) automatically by the steering system 150 of FIG. 1 in accordance with instructions provided by the processor 172 of FIG. 1. In one embodiment, the process then terminates until a subsequent turn request is made in step 402 (in some embodiments, the road monitoring of step 404 and/or the driver monitoring of step 418, discussed below, is still performed in the interim).

Conversely, if it is determined in step 414 that there is not a sufficient level of confidence that it would be safe to change lanes, then driver monitoring is performed (step 418). In various embodiments, a driver is monitored to ascertain whether the driver is looking in the direction of the intended turn. In one embodiment, the monitoring includes detection and monitoring of the position and movement of the driver's eyes. In another embodiment, the monitoring includes detection and monitoring of the position and movement of the driver's head. In yet other embodiments, the monitoring includes detection and monitoring of the position and movement of both the driver's eyes and head. Also in one embodiment, the monitoring of step 418 is performed via measurements and/or detection provided by one or more sensors of the driver detection unit 164 of FIG. 1. Similar to the discussion above, in certain embodiments the driver may be deemed to be looking in the particular direction of interest, for the decision making purposes of the process, if the driver has recently looked in the direction of interest (e.g. within a few seconds, or within a shorter time interval, which may vary in different embodiments). In one embodiment, the driver monitoring of step 418 is performed continuously, once the initiation of step 401 is made. In addition, in one embodiment, the monitoring is performed at least in part by the processor 172 of FIG. 1 based on such inputs provided by the driver detection unit 164. The process then proceeds to step 420, described directly below.

During step 420, a determination is made as to whether a driver condition is satisfied with respect to the turn. In one embodiment, this determination is made by the processor 172 of FIG. 1 based on information provided by the driver detection unit 164 of FIG. 1 in the monitoring of step 418. In one embodiment, the driver condition is satisfied if the driver is deemed to be looking in the direction of the turn. In one embodiment, the driver condition is satisfied if the driver has checked each of the relevant adjacent lanes pertaining to the turn (e.g., including the lane in which the vehicle intends to turn).

If it is determined that the driver condition is satisfied, then the process proceeds to the above-described step 416, in which the requested turn is executed. Conversely, if it is determined that the driver condition is not satisfied, then the process proceeds instead to the above-described step 410, in which a determination is made as to whether the maximum wait time has been reached.

Accordingly, in one embodiment of the process 400, the requested turn is automatically executed if there is sufficient confidence that the vehicle 100 can safely make the turn (e.g. if the lane is clear of objects). Conversely, the requested turn is not executed if there is sufficient confidence that the vehicle 100 cannot safely make the turn (e.g. if the lane is full of objects). In cases in which there is not a sufficient level of confidence as to whether the requested turn can safely be executed, the turn is executed if and only if the driver is looking or has recently looked in the appropriate direction for the turn.

With reference to FIG. 4, the vehicle 100 is depicted as being driven along a roadway 500 with a first lane 502 and a second lane 504. The vehicle 100 is being driven in the first lane 502, behind a second vehicle 505. A request may be made by a driver of the vehicle 100 for a turn into the second lane 504 (for example to pass the second vehicle 505). Before executing the turn, the vehicle 100 will monitor the second lane 504 with respect to objects (e.g. other vehicles 506) that may be in the second lane 504 (or that may be proximate to and/or approaching the second lane 504) as well as monitor the driver of the vehicle 100 to determine whether the driver is looking at an appropriate direction toward the second lane 504.

Accordingly, methods, systems, and vehicles are provided for monitoring drivers of vehicles. In various embodiments, one or more vehicle actions (e.g. providing vehicle notifications, initiating steering assist, and/or executing a requested turn) are executed based at least in part on whether the driver of the vehicle is looking in an appropriate direction with respect to the event.

It will be appreciated that the disclosed methods, systems, and vehicles may vary from those depicted in the Figures and described herein. For example, the vehicle 100, the control system 102, and/or various components thereof may vary from that depicted in FIG. 1 and described in connection therewith. In addition, it will be appreciated that certain steps of the processes 300 and/or 400 may vary from those depicted in FIGS. 3-5 and/or described above in connection therewith. It will similarly be appreciated that certain steps of the methods described above may occur simultaneously or in a different order than that depicted in FIGS. 3-5 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method comprising:
detecting whether a driver of a vehicle is looking in a direction with respect to the vehicle; and
providing an action based at least in part on whether the driver is looking or has recently looked in the direction.

2. The method of claim 1, wherein the step of detecting whether the driver is looking into the direction comprises monitoring one or more eyes of the driver.

3. The method of claim 1, wherein the step of detecting whether the driver is looking into the direction comprises monitoring a head of the driver.

4. The method of claim 1, further comprising:
determining or predicting whether a turn is to be made into a lane;
wherein:
the step of detecting whether the driver is looking in the direction comprises detecting whether the driver is looking toward the lane in which the turn is to be made; and
the step of providing the action comprises executing the turn into the lane based in part on whether the driver is looking toward the lane in which the turn is to be made.

5. The method of claim 4, wherein the step of determining or predicting whether the turn is to be made comprises monitoring a driver's action indicating a desire for the driver to have the vehicle make a turn.

6. The method of claim 4, further comprising:
monitoring whether the lane in which the turn is to be made is clear of objects;
wherein the step of providing the action comprises executing the turn into the lane based at least in part on whether the driver is looking toward the lane in which the turn is to be made and the lane is clear of objects.

7. The method of claim 1, further comprising:
monitoring whether a lane in which a turn is to be made is clear of objects;
wherein the step of providing the action comprises at least in part:
if there is a sufficient level of confidence that the lane is clear of objects, then executing the turn;
if there is a sufficient level of confidence that the lane is not clear of objects, then not executing the turn;
if there is not a sufficient level of confidence that the lane is clear of objects and there is not a sufficient level of confidence that the lane is not clear of objects, then executing the turn if and only if the driver is looking or has recently looked in the direction of the turn.

8. The method of claim 1, further comprising:
determining or predicting whether a turn is to be made into a lane;
providing a notification that the turn cannot be completed based at least in part on whether there is a sufficient level of confidence that the lane is not clear of objects, the driver is not looking and has not recently looked toward the lane in which the turn is to be made, or both.

9. The method of claim 1, further comprising:
determining whether steering assistance is required by monitoring objects in proximity to the vehicle;
wherein the step of providing the action comprises providing the steering assistance based at least in part on whether the driver is looking or has recently looked in the direction toward the objects.

10. The method of claim 1, further comprising:
determining whether a threat is present to the vehicle from the direction;
wherein the step of providing the action comprises providing a warning to the driver pertaining to the threat based at least in part on if the driver is not looking in the direction.

11. The method of claim 10, further comprising:
delaying the warning if the driver is looking in the direction.

12. A system comprising:
a sensing unit configured to at least facilitate detecting whether a driver of a vehicle is looking in a direction with respect to the vehicle; and
a processor coupled to the sensing unit and configured to at least facilitate providing an action based at least in part on whether the driver is looking or has recently looked in the direction.

13. The system of claim 12, wherein the sensing unit is configured to at least facilitate monitoring one or more eyes of the driver.

14. The system of claim 12, wherein the sensing unit is configured to at least facilitate monitoring a head of the driver.

15. The system of claim 12, wherein:
the sensing unit is configured to at least facilitate detecting whether the driver is looking toward a lane; and
the processor is configured to at least facilitate:
determining whether a turn is to be made into the lane; and
executing the turn into the lane based at least in part on whether the driver is looking toward or has recently looked toward the lane in which the turn is to be made.

16. The system of claim 15, further comprising:
a second sensing unit configured to at least facilitate monitoring whether the lane in which the turn is to be made is clear of objects;
wherein the processor is coupled to the second sensing unit and configured to at least facilitate executing the turn into the lane based at least in part on whether the driver is looking toward or has recently looked toward the lane in which the turn is to be made and the lane is clear of objects.

17. The system of claim 15, further comprising:
a notification unit;
wherein the processor is coupled to the notification unit and configured to at least facilitate providing instructions to the notification unit that the turn cannot be completed based at least in part on whether there is a sufficient level of confidence that the lane is not clear of objects, whether the driver is not looking toward or has not recently looked at the lane in which the turn is to be made, or both.

18. The system of claim 12, further comprising:
a second sensing unit configured to at least facilitate monitoring objects in proximity to the vehicle;
wherein the processor is coupled to the second sensing unit and configured to at least facilitate:
determining whether to provide steering assistance based on the monitoring of the objects in proximity to the vehicle; and
providing the steering assistance based on whether the driver is looking or has recently looked in the direction toward the objects.

19. The system of claim 12, wherein the processor is further configured to at least facilitate:
determining a threat direction from which a threat is present to the vehicle; and
providing a warning to the driver pertaining to the threat if the driver is not looking in the threat direction.

20. A vehicle comprising:
a body;
a steering system formed with the body;
a sensing unit configured to at least facilitate detecting whether a driver of the vehicle is looking or has recently looked in a direction with respect to the vehicle; and
a processor coupled to the sensing unit and the steering system and configured to at least facilitate providing a steering action based on whether the driver is looking or has recently looked in the direction.
